(19) United States
(12) Patent Application Publication
(10) Pub. No.: US 2007/0264856 A1
(43) Pub. Date: Nov. 15, 2007

(54) Coupling Apparatus with a Heat Sink

(75) Inventors: Thomas Erk, Senzig (DE); Ralf-Reiner Volkmar, Oldenburg I. H. (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/665,476

(22) PCT Filed: Sep. 20, 2005
(86) PCT No.: PCT/EP05/54688

§ 371 Date: Apr. 16, 2007

(30) Foreign Application Priority Data
Oct. 14, 2004 (DE) 10 2004 050 786.4

(51) Int. Cl. H01R 25/00

(52) U.S. Cl. 439/291

(57) ABSTRACT

A coupling device for electrically connecting a first conductor to a second conductor has a first connecting piece to connect the first conductor and a second connecting piece to connect the second conductor. The first connecting piece is joined to the second connecting piece via flexible connecting means or sliding or rolling connecting means such that a relative movement can be performed between the first conductor and the second conductor. In order to create a coupling device that features improved constant current stability while heating remains at the same level, a cooling unit is provided for cooling the coupling device.

The invention relates to a coupling apparatus for electrically connecting a first conductor to a second conductor, which coupling apparatus has a first connection piece for connecting the first conductor and a second connection piece for connecting the second conductor, the first connection piece being connected to the second connection piece via flexible connecting means, via sliding means or via rolling connecting means, with the result that a relative movement between the first conductor and the second conductor is made possible.

The invention also relates to a solid-insulated switch pole having an electrically nonconductive insulating-material housing and an interrupter tube, which is arranged in the insulating-material housing and extends between an input connection and a fixed output connection, an axially movable switching rod for introducing a drive movement into the interrupter tube being provided.

Such a coupling apparatus and such a solid-insulated switch pole are already known, for example, from DE 19 71 21 82 A1. The coupling apparatus disclosed therein has, as the first connection piece, a clamping part, which is fixedly connected to an axially movable switching rod as the first conductor. The second connection piece is arranged fixed in an insulating-material housing consisting of cast resin, in which the switching rod is guided in such a way that it is axially movable. In this case, the switching rod is rigidly connected to a moving contact of a vacuum interrupter, which is fixedly embedded in the insulating-material housing. In order to make it possible to electrically connect the movable switching rod to the connection piece which is embedded fixed in the insulating-material housing, the coupling apparatus has a flexible metallic conductor strip, which is connected on both sides to in each case one connection piece. Since there are high current transfer resistances in particular at the contact points of the conductor strip, at these points a comparatively high degree of heat generation, which is dependent on the level of the rated current, results. In order to avoid damage to the switch pole, the current-induced heating of the switch pole should not exceed 65-75 kelvin. Owing to the resultant continuous current-carrying capacity of the coupling apparatus, the maximum permissible rated current of the switch pole is limited.

The previously known coupling apparatus has the disadvantage that the heat dissipation essentially only takes place via the thermal conduction of the flexible strip, which dissipates the heat produced at the first connection piece toward the second connection piece. The second connection piece is thermally conductively connected to conductors arranged outside the insulating-material housing, with the result that the heat can thus be output to the external atmosphere.

The object of the invention is to provide a coupling apparatus and a solid-insulated switch pole of the type mentioned at the outset which have improved continuous current-carrying capacity whilst retaining the same level of heating.

The invention achieves this object, on the basis of the coupling apparatus mentioned at the outset, by virtue of the fact that a cooling unit for cooling the coupling apparatus is provided.

According to the invention, the cooling no longer takes place as in the prior art purely via the thermal conduction of the connecting means. The cooling unit provided according to the invention brings about additional local cooling of the coupling apparatus, as a result of which the heating of the coupling apparatus is considerably reduced. It is thus possible within the scope of the invention to pass higher rated currents via the coupling apparatus without in the process leaving the range of the permissible increase in temperature. The cooling unit may have any desired design in accordance with the invention. The cooling unit may therefore have water cooling, for example. It is merely essential within the scope of the invention that the cooling unit is thermally conductively connected to one or more of the remaining components of the coupling apparatus for cooling purposes.

In accordance with one preferred configuration of the invention, the cooling unit has a heat sink with cooling ribs. Owing to the cooling ribs, the heat exchange area of the coupling apparatus is considerably increased. The length of and distance between the cooling ribs are optimized to the extent that, firstly, a heat exchange area is provided which is as large as possible. Secondly, however, flow-related minimum distances between the cooling ribs also need to be maintained in order to allow for a flow rate of the air between the cooling ribs of the heat sink which is as high as possible. If the distance between the cooling ribs becomes too small as a function of their length, the rate of the air flow between the cooling ribs is reduced by air turbulence.

In principle, the arrangement of the heat sink is as desired. Expediently, however, the heat sink is thermally conductively connected to the first connection piece. Such a variant of the invention is particularly expedient when the highest degree of heat generation takes place at the first connection piece.

In a preferred variant of the invention, the flexible connecting means have at least one flexible conductor strip. A conductor strip represents a cost-effective connecting means which is susceptible to little maintenance between the connection pieces, but, at higher voltages in the region of over 100 kV, field distribution problems may arise.

Advantageously, a first contact area of each conductor strip with the first connection piece and a second contact area with the second connection piece are each twice as large as the cross-sectional area of the conductor strip. In accordance with this advantageous further development of the invention, the heat transfer areas between the conductor strip and the connection pieces are enlarged. As has already been mentioned, high current transfer losses with increased heat generation result in particular at the transfer areas. Owing to the transfer areas being enlarged, a reduction in the current transfer densities and therefore the reduction in the heat generation at the transitions between the conductor strip and the connection piece result. Each conductor strip is therefore not only, for example, soldered flush with its end side to the respective connection piece, but may have, in addition to the end side, a side face, by means of which contact is made with the respective connection piece. In this case, a step-shaped countersunk portion is provided in the connection piece.

In accordance with one advantageous further development, each conductor strip has a flexible bending section, whose length in relation to its cross-sectional area is less than 0.1 mm⁻¹. In accordance with this further development, the heat generation in the conductor strip is optimized, since, given such a ratio with the rated current remaining the same, the current per unit area in the conductor strip and therefore the heating in it is reduced.

Advantageously, the first connection piece is a clamping part to be clamped onto an axially movable switching rod. In accordance with this further development, fitting of the coupling apparatus is simplified. In particular in the case of solid-insulated conductor poles, simple fitting within limited installation volumes is made possible, with the result that the fitting and maintenance work is accelerated.

Expediently, the second connection piece has a through-opening through which a switching rod can pass freely. In this way, a switching rod can be clamped to the first connection piece, the second connection piece being embedded, for example, in the sheathing of a solid-insulated switch pole.

The object of the invention is also achieved by a solid-insulated switch pole of the type mentioned at the outset which has a coupling apparatus according to the invention which connects the switching rod and the output connection electrically to one another.

In a further development in this regard, the interrupter tube is embedded in the insulating-material housing, which has a ventilation channel interacting with the cooling unit. In this variant of the invention, the interrupter tube, preferably a vacuum interrupter, adjoins a nonconductive solid with its outer housing, with the exception of the drive parts, with the result that air circulation in the interior of the insulating-material housing is made more difficult without the ventilation channel. During operation of the switch pole, the ventilation channel is expediently arranged with its inlet opening above the cooling unit and extends upward in a straight line.

Further expedient configurations and advantages of the invention are the subject matter of the description below relating to exemplary embodiments of the invention with reference to the figures of the drawing, in which case the same reference numerals relate to functionally identical components and in which:

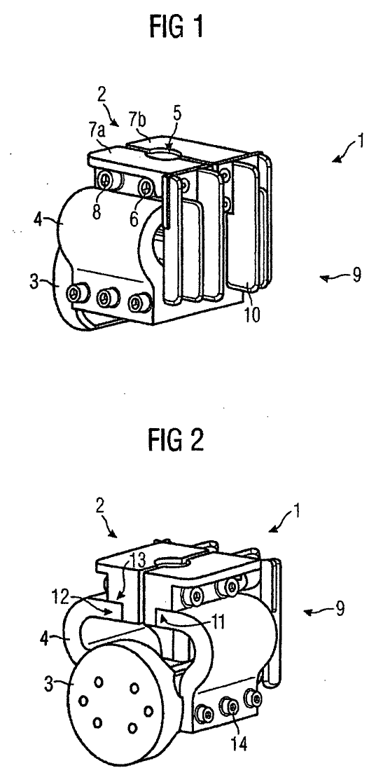

FIG. 1 shows a perspective, front view of an exemplary embodiment of the coupling apparatus according to the invention,

FIG. 2 shows a perspective view of the rear of the coupling apparatus shown in FIG. 1,

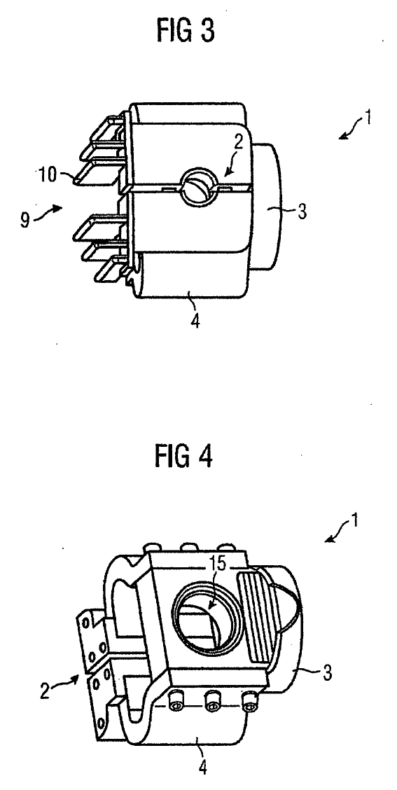

FIG. 3 shows a perspective, plan view of the upper side of the coupling apparatus shown in FIG. 1, and

FIG. 4 shows a perspective, plan view of the underside of the coupling apparatus shown in FIG. 1, without the cooling unit.

FIG. 1 shows a perspective view of an exemplary embodiment of the coupling apparatus 1 according to the invention, which has a clamping part 2 as the first connection piece and a fixed connection piece 3 as the second connection piece. The two connection pieces 2 and 3 are electrically connected to one another via two flexible strips 4.

The clamping part 2 has a clamping cutout 5, which is provided for accommodating a switching rod of a solid-insulated switch pole. In this case, the clamping part 2 has two sections 6 and 7, whose distance from one another can be varied by clamping screws 8. The clamping part 2 can therefore be clamped fixedly to the switching rod by means of the clamping screws 8. In addition, a heat sink 9 with cooling ribs 10 is shown on the clamping part, which heat sink is thermally conductively connected to the clamping part 2 and in this way enlarges the heat exchange area of the coupling apparatus 1.

FIG. 2 shows the coupling apparatus 1 shown in FIG. 1 from the rear. This perspective view of the rear shows that the clamping part 2 has a step-shaped countersunk portion 11 on each of its sections 6 and 7, at which countersunk portion 11 the flexible strip 4 is soldered with its end-side end region fixedly to the clamping part 2. Owing to the step-shaped countersunk portion 11, soldering both at the end face 12 of each flexible strip 4 and at its flat side 13 in the end-side end region is made possible, as a result of which the current transfer areas are enlarged and the heat generation owing to current transfer is reduced. In order to connect the flexible strips 4 to the fixed connection piece 3, a conventional screw connection 14 is provided, the flexible strips 4 resting flat on the fixed connection piece 3, with the result that, here too, large exchange areas are provided for heat reduction.

FIG. 3 shows the coupling apparatus shown in FIG. 1 in a plan view of the upper side. This view shows that the cooling ribs 10 have different depths, with the result that a cylindrical outer contour or envelope and therefore installation even in hollow-cylindrical installation areas, such as in tubular insulating-material housings, for example, is made possible.

FIG. 4 shows the coupling apparatus 1 from below, the heat sink 9 having been removed from the clamping part 2. It can be seen that the connection between the heat sink 9 and the clamping part 2 takes place via a screw connection. In this view it can also be seen that the fixed connection piece 3 has a through-opening 15 for the free passage of a switching rod, which through-opening 15 has a larger inner diameter than the switching rod.

1-10. (canceled)

11. A coupling apparatus for electrically connecting a first conductor to a second conductor, the coupling apparatus comprising:
a first connection piece for connecting the first conductor;
a second connection piece for connecting the second conductor;
a connector selected from the group of a flexible connection means, a sliding connecting means, and a rolling connecting means connecting said first connection piece to said second connection piece and rendering possible a relative movement between said first conductor and said second conductor; and
a cooling unit disposed to cool the coupling apparatus.

12. The coupling apparatus according to claim 11, wherein said cooling unit has at least one heat sink with cooling ribs.

13. The coupling apparatus according to claim 12, wherein said heat sink is thermally conductively connected to said first connection piece.

14. The coupling apparatus according to claim 12, wherein said connector is a flexible connector with at least one flexible conductor strip.

15. The coupling apparatus according to claim 14, wherein said at least one conductor strip has a first contact area with said first connection piece and a second contact area with said second connection piece, and said first and second contact areas are each twice as large as a cross-sectional area of said conductor strip.

16. The coupling apparatus according to claim 14, wherein said at least one conductor strip is one of a plurality of conductor strips each having a first contact area with said first connection piece and a second contact area with said second connection piece, and each of said first and second contact areas are twice as large as a cross-sectional area of said conductor strip.

17. The coupling apparatus according to claim 14, wherein each conductor strip has a flexible bending section with a length, relative to a cross-sectional area of the conductor strip, of less than 0.1 mm⁻¹.

18. The coupling apparatus according to claim 11, wherein said first connection piece is a clamping part to be clamped onto an axially movable switching rod.

19. The coupling apparatus according to claim 11, wherein said second connection piece is formed with a through-opening for enabling a switching rod to pass through freely.

20. A solid-insulated switch pole, comprising an electrically nonconductive insulating-material housing and an interrupter tube, said interrupter tube being disposed in said insulating-material housing and extending between an input connection and a fixed output connection, an axially movable switching rod for introducing a drive movement into said interrupter tube, and a coupling apparatus according to claim 1 disposed to connect said switching rod and said output connection electrically to one another.

21. The solid-insulated switch pole according to claim 20, wherein said interrupter tube is embedded in said insulating-material housing, and said insulating-material housing having a ventilation channel formed therein interacting with the cooling unit.
